(19) United States
(12) Patent Application Publication
(10) Pub. No.: US 2023/0311040 A1
(43) Pub. Date: Oct. 5, 2023

(54) DEVICE AND METHOD FOR SEPARATING GLUE PARTICLES FROM AN AEROSOL

(71) Applicant: KRONES AG, Neutraubling (DE)

(72) Inventors: Heinrich BIELMEIER, Pilsting - Grosskoellnbach (DE); Michael NEUBAUER, Grassau (DE); Christian APPEL, Ergolding (DE)

(21) Appl. No.: 18/252,504

(22) PCT Filed: Sep. 30, 2021
(86) PCT No.: PCT/EP2021/076920

§ 371 Date: May 10, 2023

(30) Foreign Application Priority Data
Nov. 23, 2020 (DE) 10 2020 130 922.8

(51) Int. Cl. B01D 45/12; B01D 47/02; B01D 50/40

(52) U.S. Cl. CPC B01D 45/12; B01D 47/027; B01D 50/40

(57) ABSTRACT

An apparatus and a method for separating glue particles from a glue aerosol are described. Accordingly, the device comprises a cyclone separator and a collection container arranged underneath for collecting glue particles running down from the cyclone separator. Due to the fact that the device further comprises a discharge line which is connected in a gas-tight manner to the cyclone separator and which projects downwards into the collection container in order to hydrostatically seal the cyclone separator at the discharge end by means of a solvent held in the collection container, separated particles can be continuously dissolved in the solvent and discharged by replacing the solvent without interruption of the cyclonic flow prevailing in the cyclone separator.

The invention relates to a device and a method for separating glue particles from a glue aerosol according to the preamble of Claims 1 or 10 and to correspondingly designed labeling units, labeling machines and labeling methods.

It is generally known that glue can be applied to labels for containers not only by means of gluing units on the basis of glue rollers but also contactlessly by means of glue jets, which are ejected, for example, from a plurality of nozzles of a glue jet printer, similar to the function of an inkjet printer.

However, this has the disadvantage that not all ejected glue particles can be placed on the respective label. A small proportion of the glue particles is carried away, for example, by air flow and thereby generates a glue aerosol drifting in the vicinity of the glue jet printer. During production operation, this leads over time to considerable contamination of machine parts in the vicinity, and results in correspondingly complicated cleaning.

For the separation of glue particles from aerosols collected in the region of hot glue rollers, a generic device based on a cyclone separator is known, for example, from DE 10 2019 203581 A1.

In such cyclone separators, particles, as is known, are separated by the cyclonic flow of the raw gas on the essentially funnel-shaped side wall and can migrate from there by gravity and/or by the cyclonic flow to the so-called expansion chamber, in which the cyclonic flow is calmed, so that in the center of the cyclonic flow the clean gas produced by the separation can flow away in the opposite direction. The separated particles can be collected in a collection container connected to the expansion chamber.

For maintaining of a functioning cyclonic flow, the cyclone separator must be sealed in an airtight manner against the environment in the region of the expansion chamber and/or the collection container connected thereto. In addition, the particles collected in this way must be removed regularly.

For this purpose, collected particles can in principle be discharged from the cyclone separator via a rotary airlock. Although this makes emptying possible during ongoing operation of the cyclone separator, it is technically comparatively complicated. Furthermore, in the case of separated glue particles, due to their inherent stickiness, this makes a difficult and/or frequent cleaning of such locks necessary. If, on the other hand, the collection container is connected or replaced without such locks, it will not be possible to maintain the cyclonic flow. An interruption to operation is therefore necessary during this time.

The invention is based on the object of specifying a device and a method for separating glue particles from a glue aerosol, which enable a discharge of separated and collected glue particles with the least possible technical effort while maintaining a continuous cyclone operation, i.e. maintaining a functional cyclonic flow.

The stated object is achieved with a device according to Claim 1, with labeling units and labeling machines equipped therewith, and with a method according to Claim 10.

The device therefore serves to separate glue particles from a glue aerosol and for this purpose comprises a cyclone separator with a separation region, which tapers in a funnel shape in particular downwards, for guiding a cyclonic flow, and arranged below the cyclone separator a collection container for collecting glue particles running out of the expansion chamber.

According to the invention, the device further comprises at least one discharge line, which is connected in a gas-tight manner to the separation region, in particular via an expansion chamber and which projects downwards into the collection container in order to hydrostatically seal the cyclone separator at the discharge end by means of a solvent held in the collection container.

The at least one discharge line consists, for example, of at least one tube and/or hose.

The glue particles are essentially pourable and/or free-flowing and thereby make gravity-driven collection possible after cyclonic separation.

The solvent serves to pick up and transport the glue particles away. The solvent is, for example, an aqueous cleaning solution, in the simplest case water. Aqueous solutions are particularly well-suited due to their relatively low volatility and ease of disposal. In principle, however, other solvents are also conceivable, for example alcohols or other organic solvents.

The discharge line preferably projects into the collection container to below a prespecified minimum fill level of the solvent during ongoing separation/cyclonic flow. During operation, the outlet of the discharge line is consistently below the minimum fill level. As a result, the device is hydrostatically sealed at the outlet end. This prevents external air from being undesirably sucked in through the discharge line and enables a reliable separation of the glue by the cyclonic flow of the glue aerosol.

The device preferably further comprises a suction unit connected to the clean gas outlet of the cyclone separator, wherein the suction power thereof is limited and/or regulated such that a negative pressure generated in the discharge line sucks the solvent through the discharge line only to such an extent that the fill level of the solvent in the collection container outside the discharge line does not fall below a prespecified minimum level.

The negative pressure in the expansion chamber and in the discharge line raises the internal fill level of the solvent in the discharge line above its external fill level in the surrounding collection container. This difference in levels can thus be adjusted in a suitable manner while maintaining the minimum fill level.

For measuring the fill level of the solvent, the collection container preferably comprises a fill level monitor arranged outside the discharge line. The fill level of the solvent in the collection container surrounding the discharge line can thus be measured continuously. If the fill level falls below an associated threshold value, in particular the minimum level, a warning signal could be output which prompts the manual refilling of solvent or which automatically triggers a corresponding machine-based refilling.

The collection container preferably comprises at least one overflow duct for the solvent in order to preset a maximum fill level of the solvent and to conduct excess solvent out of the device. During refilling with fresh solvent, the fill level initially rises up to the lower edge of the overflow duct. As a result, used solvent or solvent loaded with glue particles can be suitably diluted and discharged through the overflow duct as refilling continues and thus be replaced.

The collection container is preferably takes the form of a depression in a solvent pan which towards the depression/towards the collection container is designed as an outlet with a suitable slope in the sense of a funnel or the like. The solvent can then be poured manually from a storage container into the solvent pan, for example. There, it collects (provided the solvent pan is aligned as intended) by running down in the recessed collection container.

The cyclone separator is preferably arranged in an upright position, and the discharge line arranged centrally underneath and in particular coaxially with the separation region. This favors a cyclonic flow suitable for separation, a subsequent calming of flow in the expansion chamber and a gravity-driven discharge of the glue particles.

The device preferably further comprises an extraction system having a suction line connected to the raw gas inlet of the device and in particular having an aerosol screen arranged at the inlet end in relation to the suction line, in particular in the form of an extractor hood, and for delimiting an extraction region for the glue aerosol.

The device according to at least one of the embodiments described above and/or below is preferably part of a labeling unit for labeling containers, in particular bottles. The labeling unit then further comprises a gluing unit assigned to the device, in particular in the form of a glue jet printer for ejecting glue onto labels for the containers, and an extraction system, in particular as described above, for sucking the aerosol out of a working area of the gluing unit. Glue aerosols produced during glue application and which are drifting within the working area can be extracted in this way in a targeted manner and with a relatively low suction power, and glue particles contained therein can be separated as described.

The labeling unit is then preferably part of a labeling machine which further comprises a container carousel for, in particular, the continuous transportation of the containers during the transfer of the labels to the containers.

The described method is used for separating glue particles from a glue aerosol. For this purpose, said aerosol is guided through a separating region of a cyclone separator which tapers in a funnel-shaped manner in particular downwards. There, glue particles separated by means of cyclonic flow run/trickle into a collection container arranged underneath.

According to the invention, a solvent for the glue particles is held in the collection container. The glue particles run/trickle down into the solvent in a discharge line connected in a gas-tight manner to the separation region, in particular via an expansion chamber. Thereby, the discharge line dips into the solvent in a hydrostatically sealed manner. External air being sucked in at the discharge end through the discharge line can be reliably prevented in order to maintain a cyclonic flow that separates the glue particles.

Preferably, fresh solvent is refilled by machine and/or manually in order to maintain a minimum fill level and/or to replace loaded/used solvent in the collection container, via a solvent pan sloping down towards the collection container.

The fill level of the solvent in the collection container outside the discharge line is preferably monitored by machine. When the minimum fill level is being approached or when it is reached, a warning signal is preferably output or a machine-based replenishment of the solvent is triggered.

The solvent is preferably discharged via at least one overflow duct in order to maintain a maximum fill level in the collection container and to discharge the glue particles. This makes possible a limitation of the fill level that is technically simple and reliable.

Preferably, a suction power for the pure gas resulting from the separation of the glue particles is limited and/or regulated, whereby: a negative pressure generated in the discharge line then sucks up the solvent only to such an extent that the fill level of the solvent in the collection container outside the discharge line does not fall below a prespecified minimum level; or the minimum fill level is adapted correspondingly to the suction power.

The solvent held in the collection container is preferably at least partially replaced by fresh solvent while the cyclonic flow is maintained in the cyclone separator. As a result, the separation of the glue particles can be carried out continuously, i.e. without interruption for the purpose of discharging/disposing of the separated glue particles.

The described method is preferably a component of a method for labeling containers, wherein glue is applied to labels in particular by means of glue jet printing and in this case glue aerosols drifting into the environment are extracted and glue particles are separated therefrom using the method according to at least one of the embodiments described above or below.

The glue aerosol contains, for example, cold glue particles for labeling containers. However, any type of glue and/or glue mixtures suitable for cyclone separation are in principle conceivable.

A preferred embodiment of the invention is illustrated in the drawing. In the drawings:

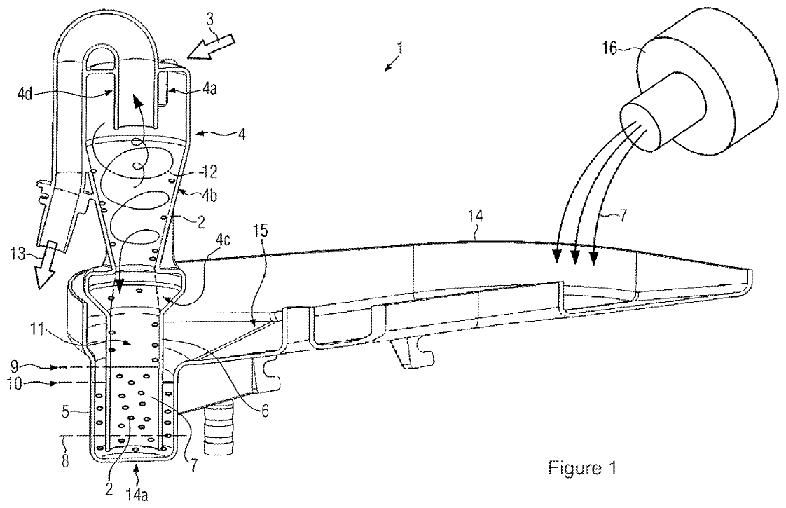

FIG. 1 shows a longitudinal section through the device;

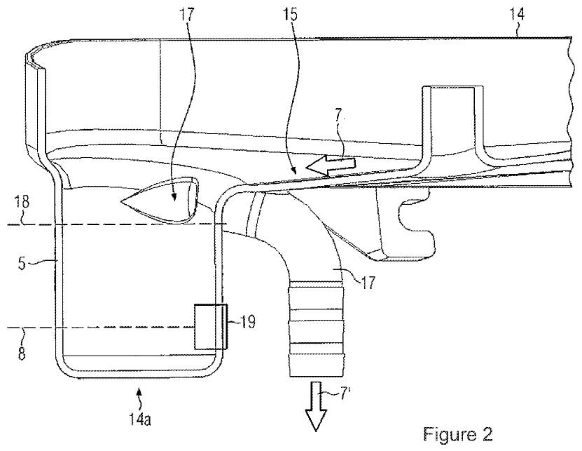

FIG. 2 shows a detailed view of the collection container; and

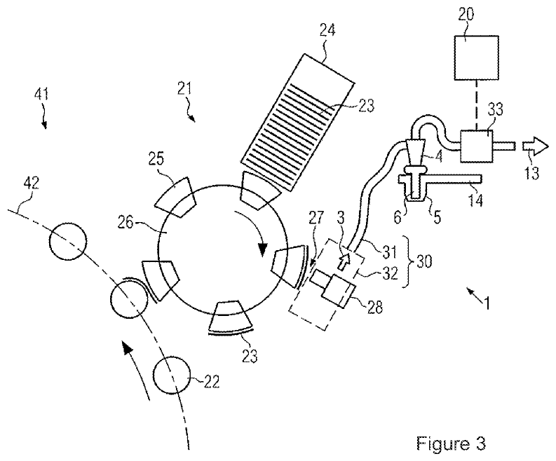

FIG. 3 shows a schematic plan view of a labeling machine with the device.

As can be seen from FIG. 1, the device 1 for separating glue particles 2 from a glue aerosol 3 comprises a cyclone separator 4 with a raw gas inlet 4a, a funnel-shaped tapering separation region 4b, an adjoining expansion chamber 4c and a clean gas outlet 4d.

These components of the cyclone separator 4 are generally known in terms of their basic structure and function and are therefore not explained in detail. The size ratios and shaping shown are to be understood merely by way of example and can be suitably adapted to the properties of the glue aerosol 3 and its glue particles 2.

The device 1 further comprises a collection container 5 arranged below the cyclone separator 4 for collecting the glue particles 2 separated in the cyclone separator 4 and running out of the separation area 4b and/or the region of the expansion chamber 4c.

The device 1 further comprises a discharge line 6, which adjoins the separation region 4b at the bottom (indicated by broken lines in FIG. 1) or downstream of the expansion chamber 4c, the discharge line extending downwards into the collection container 5 and at the discharge end hydrostatically sealing the cyclone separator 4 by means of a solvent 7 held in the collection container 5.

For this purpose, the discharge line 6 dips into the solvent 7 at least to below a minimum fill level 8 of the solvent. The minimum fill level 8 relates to a region of the collection container 5 directly surrounding the discharge line 6.

By maintaining the minimum fill level 8 of the solvent 7 in the collection container 5, an undesired sucking in of external air at the discharge end through the discharge line 6 is prevented.

In FIG. 1, by way of example an inner fill level 9 of the solvent 7 in the discharge line 6 and an outer fill level 10 of the solvent 7 outside the discharge line 6 during ongoing operation are also indicated. Accordingly, the inner fill level 9 is higher than the outer fill level 10, above which essentially the ambient pressure prevails, due to a negative pressure 11 prevailing in the region of the expansion chamber 4c and the discharge line 6 during the working operation of the cyclone separator 4.

FIG. 1 also schematically indicates a cyclonic flow 12 known in principle, with which the glue aerosol 3 in the sense of a raw gas flows helically to the expansion chamber 4c. The flow of a clean gas 13 resulting from the glue aerosol 3 after separation of the glue particles 2 is also schematically indicated.

The cyclonic flow 12 is generated by suction of the clean gas 13 in a manner known in principle . The described hydrostatic sealing of the discharge line 6 serves in this case to ensure the functional maintenance of the cyclonic flow 12 and its suitable calming in the expansion chamber 4c.

As indicated in FIG. 1, the discharge line 6 is preferably formed as a tube which is connected coaxially to the expansion chamber 4c. However, a plurality of drainage lines 6 originating in the expansion chamber 4c, likewise the formation of the at least one discharge line 6 in the form of a tube or the like, would also be conceivable. The decisive factor is that the respective discharge line 6 for maintaining the cyclonic flow 12 dips into the solvent 7 present there to below the minimum fill level 8.

The discharge line 6 is preferably a component of the cyclone separator 4, that is to say, for example, integrally formed therewith or otherwise permanently connected to the latter. However, it would also be conceivable to flange the discharge line 6 in a liquid-tight and gas-tight manner onto the cyclone separator 4, to insert it into a corresponding seating present thereon, or the like.

It can also be seen in FIG. 1 that the collection container 5 is preferably integrated into a solvent pan 14, which drops with a suitable slope 15 to the collection container 5 in the sense of a run-off for the solvent 7 poured into the solvent pan 14. Fresh solvent 7 can then be refilled manually, for example, into the solvent pan 14 from a storage container 16 during ongoing operation of the device 1.

Likewise, refilling the collection container by machine via a supply line and metering device (not shown) for fresh solvent 7 would be conceivable.

The collection container 5 is preferably designed as a depression 14a in the solvent pan 14 and then preferably forms the lowest region of the solvent pan 14 in relation to the minimum fill level 8 for the corresponding collection of the solvent 7.

As can be seen in FIG. 2 in a partial view of the device 1, the collection container 5 preferably comprises an overflow duct 17 for excess solvent 7′. During refilling with fresh solvent 7, this solvent replaces solvent 7, which is present at least partially in the collection container 5 and is loaded with glue particles 2, as soon as a maximum fill level 18 of the solvent 7 in the collection container 5 is reached that is prespecified by the lower edge of the overflow duct 17. If fresh solvent 7 is further replenished, solvent 7 loaded with glue particles 2 will run out of the apparatus 1 in the form of the schematically indicated excess solvent 7′.

This renewal process for the solvent 7 held in the device can be carried out without interruption of the cyclonic flow 12, that is to say, during ongoing operation of the device 1, as a result of which a sufficient cleaning/flushing of the discharge line 6 and of the collection container 5 is also provided and interruptions to operation for the removal of glue particles 2 from the device 1 can be avoided.

For this purpose, the collection container 5 could also comprise other structures, for example an essentially flexible wall structure in the sense of a bag or the like. Likewise, the collection container 5 could be designed as a component of the solvent pan 14 that can be replaced as part of maintenance measures.

It is also conceivable for the collection container 5 not to be designed as a component or in combination with the solvent pan 14. For example, at suitable time intervals the collection container 5 could be supplied directly with fresh solvent 7 via a supply line not only manually but also by machine. In principle, any metering devices for refilling fresh solvent 7 would be conceivable for this purpose.

It would also be conceivable to monitor the outer fill level 10 by means of a fill level monitor 19, which is merely schematically and by way of example indicated in FIG. 2. With the fill level monitor 19, it would then be possible to continuously determine during operation whether the outer fill level 10 is suitably higher than the minimum fill level 8. If this is not the case, for example if the outer fill level 10 falls below a suitable threshold value, a warning message for manual refilling of fresh solvent 7 can be output or a corresponding refilling can be triggered automatically, for example via an assigned metering device for the solvent 7.

As can be seen from FIG. 3, the device 1 can comprise an electronic control device 20 for controlling and/or regulating the power of the cyclone separator 4.

FIG. 3 also schematically shows a plan view of a labeling unit 21 for labeling containers 22 with labels 23. These are, for example, kept in stacks in a label container 24 and individually picked up by means of vacuum pallets 25 in a manner known in principle. The vacuum pallets 25 run on a pallet carousel 26 in a manner known in principle and transport the labels 23 through the working area 27 of a glue jet printer 28.

In order to extract the glue aerosol 3 out of the working area 27 of the glue jet printer 28, the device 1 then preferably further comprises an extraction system 30 with a suction line 31 and an aerosol screen 32, which can be designed, for example, in the sense of an extractor hood.

A suction unit 33 for sucking in the clean gas 13, for the indirect extraction of the glue aerosol 3 and for generating the cyclonic flow 12 is also schematically indicated.

However, it would also be conceivable to form the extraction system 30 with a separate suction unit (not shown) which would then be arranged upstream of the raw gas inlet 4a of the cyclone separator 4.

The control device 20 preferably regulates the suction power of the suction unit 33 such that a suitable negative pressure 11 is generated in the region of the expansion chamber 4c and/or of the discharge line 6. As a result, a suitable level difference between the inner fill level 9 and the outer fill level 10 can be set in order to keep the outer fill level 10 above the minimum fill level 8. This prevents the fill level from falling below the minimum fill level 8.

In addition, the fill level monitor 19 shown in FIG. 2 could be connected to the control device 20 in order to prevent a fall below the minimum fill level 8, for example by outputting suitable warning messages, triggering an automatic refilling process and/or adjusting the suction power.

FIG. 3 also schematically shows that the labeling unit 26 with the described device 1 is preferably a component of a labeling machine 41 of a circulating design in which the containers 22 to be labelled continuously circulate on a container carousel 42 during the transfer of the labels 23 to the containers 22. Such labeling processes are known in principle and are therefore not explained in detail.

The described device 1 and the described method enable an essentially continuous labeling of the containers 22 with a continuously rotating pallet carousel 26 and container carousel 42 with uninterrupted cyclonic flow 12 in the cyclone separator 4.

Here, a discharge of the glue particles 2 separated from the glue aerosol 3 and collected in the working area 27 of the glue jet printer 28 is possible without the need to interrupt the continuous labeling operation for cleaning or emptying the collection container 5.

Hydrostatic sealing of the cyclone separator 4 at the outlet end is possible to implement with structurally simple device components and/or with said device components easy to clean and/or replace during maintenance work. For example, the solvent pan 14 with the collection container 5 could be cleaned or replaced comparatively inexpensively. Likewise, a separate replacement of the collection container 5 and/or of the appropriate discharge line 6 would be conceivable within in the context of maintenance measures, that is to say outside regular production operation. In addition, the discharge line 6 has no movable components or other surfaces that may be difficult to clean.

For continuous operation during the labeling of containers 22, an inexpensive device 1 which in practical use is permanently maintenance-friendly is thus provided.

1. A device for separating glue particles from a glue aerosol, comprising a cyclone separator having a separation region, tapering in the form of a funnel, for guiding a cyclonic flow and a collection container arranged below the cyclone separator for collecting glue particles running down from the cyclone separator, wherein a discharge line which is connected in a gas-tight manner to the separation region and projects downwards into the collection container in order to hydrostatically seal the cyclone separator at the discharge end by means of a solvent held in the collection container.

2. The device according to claim 1, further comprising a suction unit connected to a clean gas outlet of the cyclone separator, wherein the suction power thereof is limited and/or regulated such that a negative pressure generated thereby in the discharge line sucks the solvent through the discharge line only to such an extent that a fill level of the solvent in the collection container outside the discharge line does not fall below a prespecified minimum level.

3. The device according to claim 1, wherein the collection container has an overflow duct for the solvent in order to preset a maximum fill level of the solvent and to conduct excess solvent or solvent loaded with glue particles out of the device.

4. The device according to claim 1, wherein the collection container is designed as a depression in a solvent pan which has a downward slope towards the depression.

5. The device according to claim 1, wherein the collection container comprises a fill level monitor, which is arranged outside the discharge line, for measuring the fill level of the solvent.

6. The device according to claim 1, wherein the cyclone separator is arranged in an upright position and the discharge line is arranged centrally underneath in relation to the separation region.

7. The device according to claim 1, further comprising an extraction system with a suction line connected to the raw gas inlet of the cyclone separator.

8. A labeling unit for labeling containers comprising the device according to claim 1, an associated gluing unit, and an extraction system for sucking the aerosol out of a working area of the gluing unit.

9. A labeling machine comprising the labeling unit according to claim 8 and comprising a container carousel for transporting the containers when the labels are being transferred to the containers.

10. A method for separating glue particles from a glue aerosol, said glue particles being guided through a separating region, which tapers downwards in a funnel shape, of a cyclone separator and the glue particles separated there by means of cyclonic flow run down into a collection container arranged below it, wherein a solvent for the glue particles is held in the collection container and said particles run down into the solvent in a discharge line which is connected in a gas-tight manner to the separation region, wherein the discharge line dips into the solvent in a hydrostatically sealing manner.

11. The method according to claim 10, wherein fresh solvent is refilled by machine in order to maintain a minimum fill level in the collection container, and/or refilled manually via a solvent pan sloping down towards the collection container.

12. The method according to claim 10, wherein the solvent is discharged through at least one overflow duct in order to maintain a maximum fill level in the collection container and to discharge the glue particles.

13. The method according to claim 11, wherein a suction power for the pure gas resulting after separation of the glue particles is limited and/or regulated, and wherein: a negative pressure resulting therefrom in the discharge line sucks up the solvent only to such an extent that the fill level of the solvent in the collection container outside the discharge line does not fall below a prespecified minimum level or the minimum fill level is adapted correspondingly to the suction power.

14. The method according to claim 10, wherein the solvent held in the collection container is at least partially replaced while the cyclonic flow is maintained in the cyclone separator.

15. A method for labeling containers, wherein glue is applied to labels, and a glue aerosol which is discharged into and drifts in the environment is extracted and with the method according to claim 10 glue particles are separated therefrom.
